(19) United States
(12) Patent Application Publication
(10) Pub. No.: US 2011/0028624 A1
(43) Pub. Date: Feb. 3, 2011

(54) Polymer Compositions That Include High Solvating Plasticizer And Surfactant

(75) Inventors: William D. Arendt, Libertyville, IL (US); Makarand Joshi, Grayslake, IL (US); Mirnahini Jeganathan, Lake Villa, IL (US)

Correspondence Address: BRETT L. NELSON;EASTMAN CHEMICAL COMPANY, 100 NORTH EASTMAN ROAD, KINGSPORT, TN, 37660-5075, US

(73) Assignee: GENOVIQUE SPECIALTIES HOLDINGS CORPORATION, Rosemont, IL (US)

(21) Appl. No.: 12/512,149

(22) Filed: Jul. 30, 2009

(51) Int. Cl. C08K 5/11; C08K 5/101; C08K 5/12; C08L 33/00; C08L 27/06

(52) U.S. Cl. 524/296; 524/287; 524/310; 524/556; 524/569

(57) ABSTRACT

A polymer composition is provided that includes plastisols and organosols having reduced viscosities and which provide desirable physical properties in films or shaped articles formed from the polymer compositions. The polymer composition includes a finely divided polymer and a liquid phase comprising at least one high solvating plasticizer. The polymer composition includes at least one surfactant having a hydrophilic/lipophilic balance (HLB) value of 12 or more.

This invention relates to plasticized polymer compositions. More particularly, polymer compositions are provided that include plastisols and organosols containing at least one high solvating plasticizer in combination with a surfactant having a hydrophilic/lipophilic balance (HLB) of 12 or more that is effective for substantially and unexpectedly reducing the viscosity of the polymer composition.

### BACKGROUND

Plastisols include a suspended phase of a film-forming (co)polymer such as polyvinyl chloride and a plasticizer for the (co)polymer. These compositions also typically include solvents, PVC blending resins, fillers, pigments, heat stabilizers, auxiliary plasticizers and other additives to modify the physical and/or mechanical properties of the composition and shaped articles formed from the composition.

Esters of aromatic mono- and dicarboxylic acids, including but not limited to benzoic and the isomeric phthalic acids are two of the more popular class of plasticizers for plastisols and organosols. Esters of benzoic acid and glycols or dihydric alcohols offer the advantages of being good solvators for polyvinyl chloride and other polymers typically used as the liquid phase for the dispersed polymer of plastisols, thereby facilitating rapid fabrication of the plastisol to form the desired film or shaped article. The resultant high viscosity of the plastisol is typically reduced to a more readily processable level using solvents, auxiliary plasticizers and/or PVC blending resins. Plastisols containing more than about 5 weight percent of organic liquids as solvents are typically referred to as organosols.

A need exists to provide additives for plastisols and organosols, containing benzoic acid esters as plasticizers that substantially reduce the viscosity of these polymer compositions without adversely affecting fabrication of the compositions or the physical properties of films or shaped articles formed from the compositions.

### SUMMARY

A polymer composition is provided that includes plastisols and organosols having reduced viscosities and which provide desirable physical properties in films or shaped articles formed from the polymer compositions. The polymer composition includes a finely divided polymer and a liquid phase comprising at least one high solvating plasticizer. In an important aspect, the polymer composition includes at least one surfactant having a hydrophilic/lipophilic balance (HLB) value of 12 or more.

The polymer composition includes from about 30 to about 60 weight percent of the polymer, based on a total weight of the polymer composition. Polymers which may be used in include homopolymer and copolymers of vinyl halides, acrylic polymers, and mixtures thereof. In an important aspect, the polymer is polyvinyl chloride.

The polymer composition also includes from about 5 to about 60 weight percent high solvating plasticizer, based on a total weight of the polymer composition. High solvating plasticizer which may be utilized include dibenozates of a diol, dibenzoates of a glycol, dibenzoates of oligomeric glycol, and mixtures thereof. In an important aspect, the high solvating plasticizer is diethylene glycol dibenzoate.

The polymer composition also includes from about 0.1 to about 2 parts by weight per 100 parts polymer composition non-ionic surfactant having an HLB value of about 12 to about 30, preferably about 12 to about 20. The non-ionic surfactant may includes ethoxylated octyl phenols, copolymers of ethylene and propylene oxides, and mixtures thereof.

The polymer composition may further include other plasticizers, diluent plasticizer(s) and diluent. Other plasticizers that may be utilized include esters of ortho, iso and terephthalate, esters of citric acid, esters of 1,2-, 1,3- and 1,4-cyclohexane dicarboxylic acid, and anhydrides. Diluent plasticizers such as 2-ethylhexyl benzoate, isodecyl benzoate or 2,2,4-trimethyl-1,3-pentanediol diisobutyrate may also be used to control rheology and other properties. Diluents which may be utilized include aromatic hydrocarbon, cycloaliphatic hydrocarbon, and aliphatic hydrocarbons.

In another aspect, a method is provided for reducing viscosity of plastisols and organosols. The method includes blending polymers with a high solvating plasticizer and at least one surfactant having an HLB value of 12 or more.

### DETAILED DESCRIPTION

The polymer composition includes a plastisol or organosol. As used herein, the term “plastisol” refers to liquid polymer compositions comprising a particulate form of at least one organic polymer suspended in a liquid medium that includes at least one plasticizer for the polymer and at least one liquid organic compound that functions as a diluent. Plastisols containing a total of more that about five weight percent of one or more of these liquid diluents in addition to the required plasticizers are also referred to as “organosols”. In plastisols and organosols, the liquid phase contains plasticizer and surfactants together with any optional additives.

### Polymers

The types of polymers typically used in plastisols and organosols in combination with the present benzoate ester plasticizers include but are not limited to homo- and copolymers of vinyl halides such as vinyl chloride, and the group of homo- and copolymers of esters of acrylic and methacrylic acids commonly referred to as “acrylic polymers”. Homo- and copolymers of vinyl chloride and acrylic polymers are preferred based on their wide range of commercial utility. As used herein, “finely divided polymer” means a dispersion polymer having a particle size of about 0.5 to about 4 microns, and a blending polymer having a particle size of about 10 to about 20 microns.

In this aspect, the polymer composition will include form about 30 to about 60 weight percent film-forming polymer, and preferably from about 30 to about 50 weight percent polymer, all based on a total weight of the polymer composition.

### High Solvating Plasticizer

“High Solvating” is a generic term that describes the efficiency of a plasticizer's ability to penetrate and soften the polymer. An aggressive or high solvating type plasticizer will, in many cases, soften the polymer faster thus reducing process temperatures and expediting the transformation of the solid polymer into the plastic or melt phase.

The highly solvating plasticizer of the present compositions are dibenzoates of a diol, glycol or oligomeric glycol. Some examples of high solvating plasticizers that may be utilized include diethylene glycol dibenzoate, dipropylene glycol dibenzoate, triethylene glycol dibenzoate, and mixtures thereof. In an important aspect, the high solvating plasticizer is diethylene glycol dibenzoate. The polymer composition may include from about 5 to about 50 weight percent high solvating plasticizer, preferably from about 20 to about 40 weight percent high solvating plasticizer, based on a total weight of the polymer composition.

### Surfactants

The definition of hydrophilic/lipophilic balance (HLB) of surfactants and methods for determining this parameter are discussed in an article in the third edition of The Encyclopedia of Chemical Technology published by Wiley Interscience, John Wiley and Sons, New York, beginning on page 910, which is incorporated herein by reference. This term is an expression of the relative simultaneous attraction of a particular surfactant, also referred to as an emulsifier in certain end-use applications, for the two immiscible phases (such as aqueous and non-aqueous) of the system being considered. The HLB value for a given surfactant is based on the chemical composition and extent of ionization of the surfactant. For example, propylene glycol monostearate, with relatively high fatty acid content, is considered lipophilic and has a low value of HLB. By contrast, polyoxyethylene monostearate is hydrophilic due to its long oxyethylene chain and is assigned a high HLB value.

A totally hydrophilic molecule would be considered 100 percent hydrophilic. In reality surfactants exhibit a fraction of this total (100%) hydrophilic character. In order to deal with smaller numbers a formula E/5 has been devised to represent the HLB for molecules where E represents weight percent of the hydrophilic portion of the molecule.

The HLB values for many non-ionic surfactants are published. The HLB values for others can be calculated using either the foregoing formula or the saponification number (S) of an ester type surfactant using the formula HLB=20(1−S/A) where “A” is the acid number of the fatty acid portion of the surfactant. The HLB values of other types of non-ionic surfactants as well as all ionic surfactants can be estimated by blending them in various ratios with an emulsifier of known HLB value and using the blend to emulsify an oil of know required HLB. The best performing blend, i.e. the one yielding the most stable emulsion, is considered to have an HLB substantially equal to that of the unknown.

A publication entitled “The HLB System” distributed by ICI United States Inc. contains a detailed discussion emphasizing that once a range of HLB values has been established the particular class(es) of surfactants suitable for a particular end use application can be readily estimated by the types and concentration of functional and non-functional groups present in the composition.

The use of a surfactant in a plastisol is not typically used to produce an emulsion and therefore the HLB would not normally be considered an important consideration in the formulation of a plastisol or organosol. Unexpectedly, it has been discovered that the proper HLB of an additional surfactant is important. In addition to possessing an HLB value within the present range, selection of the proper surfactant or surfactants for a particular plastisol, organosol or aqueous plasticized polymer composition is based on a number of additional considerations. One of these considerations is the presence on the surfactant of functional and/or linking groups, i.e. ester, hydroxyl, ether, etc. that are chemically compatible with the other ingredients of the polymer composition. Based on the presence of these groups surfactants are typically classified as cationic, anionic and non-ionic. Surfactants suitable for use in the present compositions are preferably non-ionic. Particularly preferred surfactants are the ethoxylated octyl phenols available under the Triton tradename, the C₁₁₋₁₄ secondary alcohol ethoxylates available under the Tergitol® tradename and block copolymers of propylene and ethylene oxides available under the Pluronic® tradename.

Other suitable non-ionic surfactants include but are not limited to block copolymers of ethylene and propylene oxides, such as Pluronic L44 exhibiting an HLB value of 14 and ethoxylated alcohols ethoxylated alcohols such as Tergitol 15-S-30 available from the Dow Chemical Corporation. Particularly preferred surfactants include ethoxylated octyl phenols with HLB values of 13.4, 14.4, and 17.6, available as the Triton® series from Dow Chemical company.

The present invention allows use of environmentally friendly surfactants in place of typically used types such as alkyl phenol ethoxlyates. Examples of environmentally friendly surfactants exhibiting HLB values above 12 include but are not limited to ethoxylates of secondary alcohols and copolymers of ethylene and propylene oxides.

### Other Plasticizers

Other plasticizers (auxiliary plasticizers) may be blended with the benzoate esters of the invention in the formulation of either a plastisol or an organosol. Examples of other plasticizers are as follows: esters of ortho, iso and terephthalate such as di-2-ethylhexyl phthalate (DOP), di-2-ethylhexyl terephthalate (DOTP), diisononyl phthalate (DINP), disiodecylphthalate (DIDP) and the like; esters of citric acid such as acetylated tributyl citrate (A4); esters of 1,2 or 1,4 or 1,3- cyclohexane dicarboxylic acid or anhydride such as diisononyl-1,2-cyclohexane dicarboxylate (BASF's DINCH); or, the like. Blends with other plasticizer families and specific types with benzoates may also be utilized.

Typical diluent plasticizers include but are not limited to Eastman TXIB (available from Eastman Chemical) and benzoates of monohydric alcohols such as 2-ethylhexyl benzoate Benzoflex® 181 land isodecyl benzoate Benzoflex 131, and esters of polyhydric alcohols such as glycerin with aliphatic carboxylic acids such as butyric acid.

Other plasticizers are utilized, the polymer composition may include from about 5 to about 40 weight percent other plasticizer, preferably from about 10 to about 20 weight percent other plasticizer, based on a total weight of the polymer composition. Diluent plasticizers are used from 3 to 15% of the polymer composition but more typically in the range of 5 to 10% weight.

### Diluent

To facilitate processing the plastisols and organosols of this invention typically contain in addition to polymer, plasticizer and surfactant small amounts other conventional additives such as solvent diluents and/or auxiliary plasticizers. The surfactant can be added to a polymer together with the plasticizer, with the plasticizer in combination with other additives and/or modifiers or following addition of these additives and modifiers.

Mixtures of cycloaliphatic hydrocarbons alone or in combination with linear and branched aliphatic hydrocarbons are suitable diluents for plastisols containing polyvinyl chloride and at least one glycol ester of benzoic acid as the primary plasticizer. The total concentration of all diluents is typically from about 2 to about 55 percent, preferably from about 10 to 50 percent, based on the total weight of the plasticizer and any other liquid ingredients present in the plastisol.

Preferred diluents include but are not limited to hydrocarbons and esters that are liquids at 25° C. Liquid hydrocarbons are typically supplied as mixtures of aromatic and/or aliphatic hydrocarbons boiling within a specified temperature range.

In addition to the ingredients listed in the preceding paragraphs the plastisols and organosols of this invention can include additional solid and/or liquid ingredients including but not limited to

Fillers such as calcium carbonate;

Heat stabilizers such as the calcium and barium salts of fatty acids;

Esters of phosphoric acid;

Foaming agents such as azocoarbonamides;

Foaming catalysts such as zinc oxide;

Flame retarding agents;

U.V. absorbers; and

Pigments such as titanium dioxide

### EXAMPLE 1

The Plastisols of this invention were prepared by blending the following types and amounts of ingredients to homogeneity:
92 parts of a dispersion type vinyl chloride resin available as Geon 173;
43 parts of a mixture containing 65 weight percent of diethylene glycol dibenzoate and 29 weight percent of dipropylene glycol dibenzoate together with 6 percent of the corresponding monobenzoates as the primary plasticizer;
11 parts of 2,2,4-trimethyl-1,3-pentanediol diisobutyrate (Eastman TXIB) as a diluent plasticizer;
6 parts of a mixture of cycloaliphatic and isoparrafinnic hydrocarbons available as LPA-210 from Sassol;
one of six different surfactants at concentrations of 0.39, 0.77 and 1.15 parts by weight per 100 parts of polyvinyl chloride;
7 parts of a Ca/Zn/triphenylphosphophate heat stabilizer available as ThermChek® from Ferro and
8 parts of a PVC blending resin.
   The trade names and HLB values of the six surfactants evaluated are listed in Table 1. All of the surfactants were ethoxylated octyl phenols.

TABLE 1

| Plastisol No. | Surfactant | HLB Value of Surfactant |
|---|---|---|
| 1 | Triton ® X-15 | 4.5 |
| 2 | Triton ® X-35 | 7.8 |
| 3 | Triton ® X-45 | 9.8 |
| 4 | Triton ® X-100 | 13.4 |
| 5 | Triton ® X-102 | 14.4 |
| 6 | Triton ® X-405 | 17.6 |

The viscosities of the 18 plastisols were measured at ambient temperature and the results are recorded in Table 2.

| | Surfactant Concentration | |
|---|---|---|
| Plastisol | Parts per 100 parts of PVC | Viscosity (mPa · s) |
| 1 | 0 | 895 |
| 1 | 0.39 | 840 |
| 1 | 0.77 | 790 |
| 1 | 1.15 | 790 |
| 2 | 0.39 | 825 |
| 2 | 0.77 | 800 |
| 2 | 1.15 | 800 |
| 3 | 0.39 | 880 |
| 3 | 0.77 | 825 |
| 3 | 1.15 | 800 |
| 4 | 0.39 | 770 |
| 4 | 0.77 | 740 |
| 4 | 1.15 | 740 |
| 5 | 0.39 | 770 |
| 5 | 0.77 | 690 |
| 5 | 1.15 | 690 |
| 6 | 0.39 | 690 |
| 6 | 0.77 | 690 |
| 6 | 1.15 | 645 |

### EXAMPLE 2

This example demonstrates the effect of changing the HLB of the surfactant on the viscosity of a plastisol.

Plastisols were prepared as described in Example 1 using the same types and amounts of ingredients with the exception of the surfactant. The surfactants used were the ethoxylated octyl phenol identified as Triton X-405 in table 1 and referred to hereinafter as A, a C₁₁₋₁₄ secondary alcohol ethoxylate available as Tergitol 15-S-30, with an HLB value of 17.4, referred to hereinafter as B, and a block copolymer of ethylene and propylene oxides available as Pluronic L-35 with an HLB number of 19, referred to hereinafter as C. The concentration of the surfactants was 0.46 percent based on the total weight of the plastisol, equivalent to a concentration of 0.84 weight percent based on the weight of the PVC resin.

The viscosities of compositions A and B were 725 mPa·s and the viscosity of C was 750 mPa·s compared with a viscosity of 900 mPa·s for a plastisol with the same ingredients but using as the surfactant an alkyl phenol ethoxylate with an HLB value of between 7 and 8.

That which is claimed is:

1. A polymer composition selected from the group consisting of plastisols and organosols, the polymer composition comprising a finely divided polymer and a liquid phase comprising at least one high solvating plasticizer, wherein the polymer composition includes at least one surfactant having a hydrophilic/lipophilic balance (HLB) value of 12 or more.

2. The polymer composition of claim 1 wherein the film forming polymer is selected from the group consisting of the homopolymer and copolymers of vinyl halides, acrylic polymers, and mixtures thereof.

3. The polymer composition of claim 2 where the polymer is polyvinyl chloride.

4. The polymer composition of claim 1 wherein the polymer composition includes from about 30 to about 60 weight percent polymer, based on a total weight of the polymer composition.

5. The polymer composition of claim 1 wherein the high solvating plasticizer is selected from the group consisting of dibenozates of a diol, dibenzoates of a glycol, dibenzoates of oligomeric glycol, and mixtures thereof.

6. The polymer composition of claim 5 wherein the high solvating plasticizer is diethylene glycol dibenzoate.

7. The polymer composition of claim 1 wherein the polymer composition includes from about 5 to about 50 weight percent high solvating plasticizer, based on a total weight of the polymer composition.

8. The polymer composition of claim 1 wherein the surfactant is a non-ionic surfactant selected from the group consisting of ethoxylated octyl phenols, copolymers of ethylene and propylene oxides, and mixtures thereof.

9. The polymer composition of claim 1 wherein the surfactant has a HLB value of about 12 to about 30.

10. The polymer composition of claim 1 wherein the surfactant is a non-ionic surfactant and the polymer composition includes from about 0.1 to about 2 parts by weight per 100 parts polymer composition of non-ionic surfactant.

11. The polymer composition of claim 1 further comprising at least one other plasticizer selected from the group consisting of esters of ortho, iso and terephthalate, esters of citric acid, esters of 1,2-, 1,3- and 1,4-cyclohexane dicarboxylic acid, and anhydrides.

12. The polymer composition of claim 11 wherein the polymer composition includes from about 5 to about 40 weight percent of another plasticizer, based on the weight of the polymer composition.

13. The polymer composition of claim 1 further comprising at least one diluent plasticizer selected from the group consisting of benzoates of monohydric alcohols, esters of polyhydric alcohol, and mixtures thereof.

14. The polymer composition of claim 13 wherein the polymer composition includes from about 3 to about 15 weight percent diluent plasticizer, based on the weight of the polymer composition.

15. The polymer composition of claim 1 further comprising at least one diluent selected from the group consisting of aromatic hydrocarbon, cycloaliphatic hydrocarbon, and aliphatic hydrocarbons.

16. A method for reducing viscosity of plastisols and organosols, the method comprising blending a film-forming polymer with a high solvating plasticizer and at least one surfactant having an HLB value of 12 or more.

17. The method of claim 16 wherein the film forming polymer is selected from the group consisting of the homopolymer and copolymers of vinyl halides, acrylic polymers, and mixtures thereof.

18. The method of claim 17 where the film forming polymer is polyvinyl chloride.

19. The method of claim 16 wherein the polymer composition includes from about 30 to about 60 weight percent film-forming polymer, based on a total weight of the polymer composition.

20. The method of claim 16 wherein the high solvating plasticizer is selected from the group consisting of dibenozates of a diol, dibenzoates of a glycol, dibenzoates of oligomeric glycol, and mixtures thereof.

21. The method of claim 20 wherein the high solvating plasticizer is diethylene glycol dibenzoate.

22. The method of claim 16 wherein the polymer composition includes from about 30 to about 60 weight percent high solvating plasticizer, based on a total weight of the polymer composition.

23. The method of claim 16 wherein the surfactant is a non-ionic surfactant selected from the group consisting of ethoxylated octyl phenols, copolymers of ethylene and propylene oxides, and mixtures thereof.

24. The method of claim 16 wherein the surfactant has a HLB value of about 12 to about 30.

25. The method of claim 16 wherein the surfactant is a non-ionic surfactant and the polymer composition includes from about 0.1 to about 2 parts by weight per 100 parts polymer composition of non-ionic surfactant.

26. The method of claim 16 wherein the polymer composition further comprises at least one other plasticizer selected from the group consisting of esters of ortho, iso and terephthalate, esters of citric acid, esters of 1,2-, 1,3- and 1,4-cyclohexane dicarboxylic acid, and anhydrides.

27. The method of claim 26 wherein the polymer composition includes from about 30 to about 60 weight percent of another plasticizer, based on the weight of the polymer composition.

28. The method of claim 16 further comprising at least one diluent plasticizer selected from the group consisting of benzoates of monohydric alcohols, esters of polyhydric alcohol, and mixtures thereof.

29. The method of claim 28 wherein the polymer composition includes from about 3 to about 15 weight percent diluent plasticizer, based on the weight of the polymer composition.

30. The method of claim 16 wherein the polymer composition further comprises at least one diluent selected from the group consisting of aromatic hydrocarbon, cycloaliphatic hydrocarbon, and aliphatic hydrocarbons.
